(19) United States
(12) Patent Application Publication
(10) Pub. No.: US 2004/0224546 A1
(43) Pub. Date: Nov. 11, 2004

(54) Connection device for selectably retrieving signals

(76) Inventor: Chi-Chao Hung, Tai-Shan Xiang (TW)

Correspondence Address: SNELL & WILMER, ONE ARIZONA CENTER, 400 EAST VAN BUREN, PHOENIX, AZ, 850040001

(21) Appl. No.: 10/840,498

(22) Filed: May 6, 2004

(30) Foreign Application Priority Data
May 9, 2003 (TW) 92112742

(51) Int. Cl. H01R 29/00

(52) U.S. Cl. 439/188

(57) ABSTRACT

A connection device for a cable to selectively retrieve electrical signals in a is provided. The connection device is connected to a first unit and a second unit, and includes a first conductive wire set and a second conductive wire set. During debugging or testing, one plugs the cable in the connection device to separate the first conducive wire set and the second conductive wire set so that the signals coming from either the first unit or the second unit can be retrieved separately.

### CROSS-REFERENCE TO RELATED APPLICATION

This Application claims priority to Taiwan Patent Application No. 092112742 filed on May 9, 2003.

### FIELD OF INVENTION

The present invention relates to a connection device of a for a retrieval device to selectively retrieve electrical signals.

### BACKGROUND OF THE INVENTION

With the progress of integrated circuit manufacture techniques, more and more integrated circuits can fit into one single . However, this increases the complexity of the circuit layout and signal transmission. To ensure the stability and accuracy of the system, testing before use becomes important.

To facilitate testing, the system is generally divided into several units based on their functionality and each of the units is electrically connected to others to transmit signals. During testing, one can isolate one of the units by cutting off the connections between it and the others, for example, to retrieve only the signals from the specific unit to determine its functionality without signal interference coming from other units. FIG. 1 shows an example. The system 1 includes two units, a first unit 101 and a second unit 103, with connections in between to transmit signals. When manufacturing the system 1, one can embed a signal retrieval device 105, a first resistor array 107 and a second resistor array 109 to facilitate retrieving signals from either the first unit 101 or the second unit 103. The signal retrieval device 105 is configured to connect to a cable for retrieving the signals flowing through the signal retrieval device 105. It is noted that signals can be transmitted between the first unit 101 and the second unit 103 without plugging the cable if the connections are not cut off The first resistor array 107, having zero resistivity, is embedded between the first unit 101 and the signal retrieval device 105. The second resistor array 109, having zero resistivity, is embedded between the second unit 103 and the signal retrieval device 105.

If one needs to retrieve the signals of the first unit 101, the second resistor array 109 will be cut off so that the signals of the second unit 103 cannot reach the signal retrieval device 105. Once a cable is plugged into the signal retrieval device 105, only the signals from the first unit 101 will be retrieved and therefore one can test the functionality of the first unit 101 without signal interference from the second unit 103. Similarly, one can retrieve the signals of the second unit 103 by cutting of the first resistor array 107 and thereby determine the functionality of the second unit 103.

It is however a complicated process to cut off the first resistor array 107 or the second resistor array 109 for testing. Moreover, after testing, the first resistor array 107 or the second resistor array 109 needs to be welded back before the system 1 can function normally. Hence, using the structure of the signal retrieval device 105, the first resistor array 107 and the second resistor array 109 for testing is costly and time-consuming.

### SUMMARY OF THE INVENTION

The present invention provides a connection device for a retrieval device to selectably retrieve an electrical signal while testing or debugging, and a system with such a connection device. The connection device, connected to a first unit and a second unit, includes a first conductive wire set and a second conductive wire set. The first conductive wire set has a first end and a second end, wherein the first end is electrically connected to the first unit. The second conductive wire set also has a first end and a second end, wherein the first end of the second conductive wire set is electrically connected to the second unit. When the retrieval device is not plugged in the connection device, the second end of the first conductive wire set and the second end of the second conductive wire set are electrically connected so that the first unit and the second unit are electrically connected, which means signals can be transmitted between the first unit and the second unit. When the retrieval device is plugged in the connection device for testing or debugging, the retrieval device separates the second end of the first conductive wire set and the second end of the second conductive wire set to retrieve electrical signals coming from either the first unit or the second unit.

### BRIEF DESCRIPTION OF THE DRAWINGS

FIG. 1 illustrates an example of the connection device of the prior art;

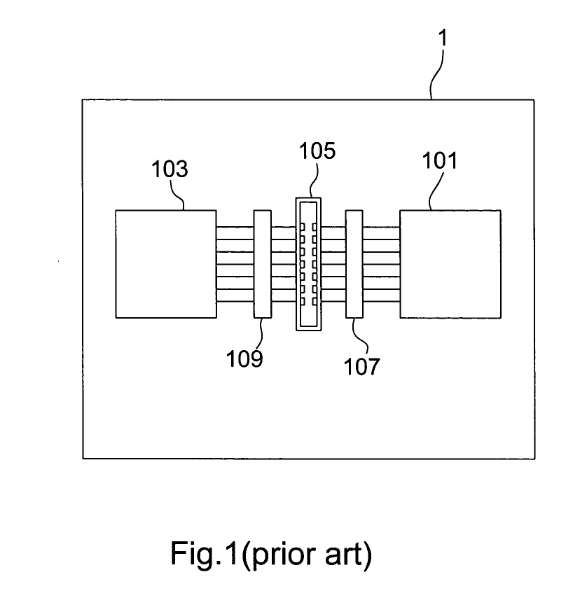

FIG. 2A illustrates a lateral view of a first embodiment of the present invention;

FIG. 2B illustrates a pictorial drawing of the first embodiment of the present invention;

FIG. 3 illustrates a lateral view of a second embodiment of the present invention;

FIG. 4A illustrates a pictorial drawing of a third embodiment of the present invention; and

FIG. 4B illustrates a lateral view of the third embodiment of the present invention.

### DETAILED DESCRIPTION

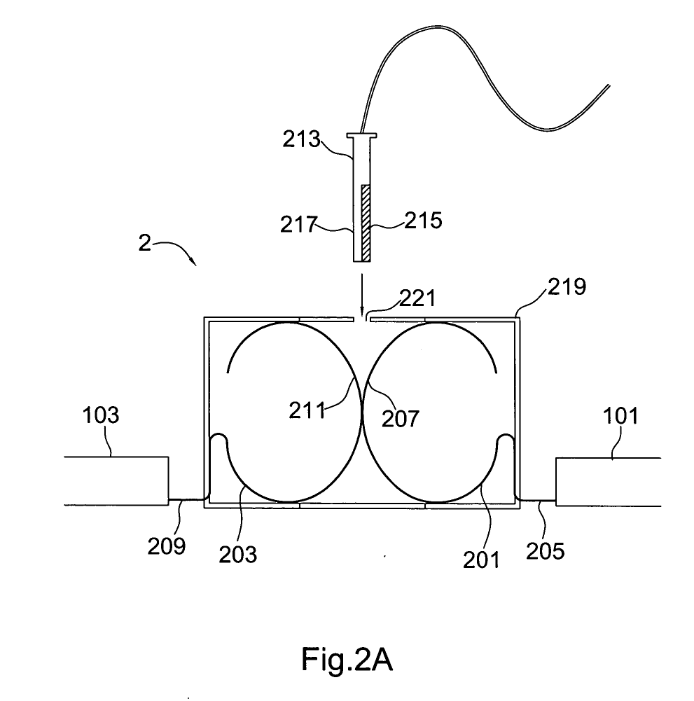

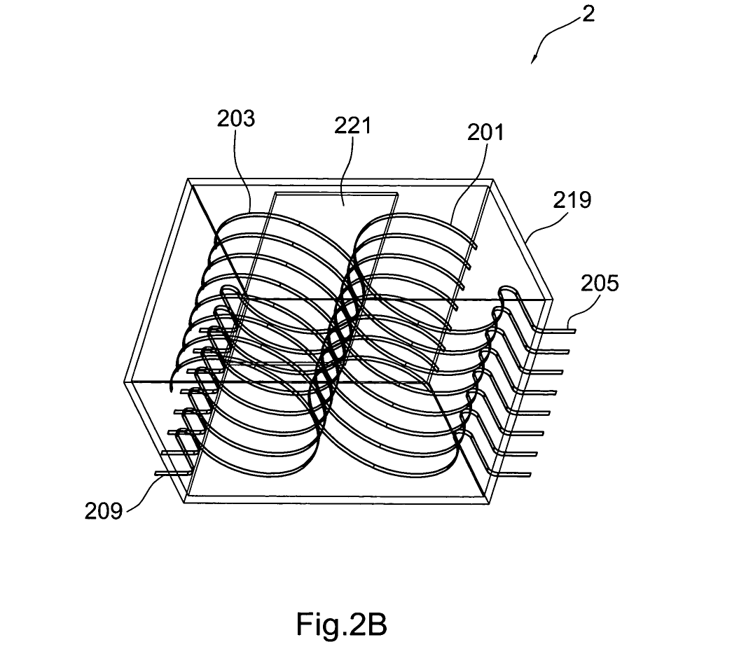

FIG. 2A and FIG. 2B illustrate one embodiment of the present invention. The connection device 2 is connected to a first unit 101 and a second unit 103, and includes a first conductive wire set 201 and a second conductive wire set 203. The first unit 101 and the second unit 103 are included in the same system but are divided according to their functionalities. Both the first conductive wire set 201 and the second conductive wire set 203 are arc-shaped. The first conductive wire set 201 has a first end 205 and a second end 207, wherein the first end 205 is electrically connected to the first unit 101 by weld. The second conductive wire set 203 has a first end 209 and a second end 211, wherein the first end 209 is electrically connected to the second unit 103 by welding. In this embodiment, at least one of the second end 207 of the first conductive wire set 201 and the second end 211 of the second conductive wire set 203 is elastic and such that ends 207, 211 are able to contact each other in the way as FIG. 2A and FIG. 2B show.

The connection device 2 is capable of receiving a retrieval device. In the first embodiment, it is a flexible flat cable 213 including a signal line 215 for transmitting signals on one side and a flexible plastic insulator 217 for insulation on the other side.

When the cable 213 is not plugged in the connection device 2, the second end 207 of the first conductive wire set 201 and the second end 211 of the second conductive wire set 203 contact with each other, which means they are electrically connected. In other words, the first unit 101 and the second unit 103 are electrically connected as well so signals may be transmitted between the first unit 101 and the second unit 103.

When the cable 213 is plugged in the connection device 2 in the direction as FIG. 2A shows, the cable 213 separates the second end 207 of the first conductive wire set 201 and the second end 211 of the second conductive wire set 203. Hence, the signal line 215 contacts the second end 207 of the first conductive wire set 201, and the flexible plastic insulator 217 contacts the second end 211 of the second conductive wire set 203. Now the signals of the first unit 101 can go through the cable 213, but the signals of the second unit 103 are blocked by the flexible plastic insulator 217. The other end of the cable 213 might be connected to a signal analyzer or the like so it can determine the functionality of the first unit 101 without signal interference from the second unit 103.

If, instead of the first unit 101, it is the second unit 103 that needs to be tested, one simply reverses the cable 213 and plugs it in the connection device 2. Now the signal line 215 contacts the second end 211 of the second conductive wire set 203 and the flexible plastic insulator 217 contacts the second end 207 of the first conductive wire set 201. The signals of the second unit 103 can go through the cable 213, but the signals of the first unit 101 are blocked by the flexible plastic insulator 217. Therefore, the signal analyzer can determine the functionality of the second unit 103 without signal interference from the first unit 101.

The connection device 2 further includes a casing 219 for receiving the first conductive wire set 201 and the second conductive wire set 203. The casing 219 has an opening 221 for the cable 213 to be plugged in the connection device 2.

The retrieval device of the present invention is not limited to a flexible flat cable set forth in the first embodiment. It might be, for example, a device with conductive wires appropriately arranged on a circuit board, or a probe with a conductor on one side and an insulator on the other side. Moreover, the retrieval device might be designed as the cable 213 of the first embodiment with two signal lines 215 on both sides respectively connected to the first unit 101 and the second unit 103. It is noted that the two signal lines 215 do not contact with each other. When the retrieval device is plugged in the connection device 2, the signals of the first unit 101 and the second unit 103 can be retrieved at the same time via the cable 213 without interfering with each other.

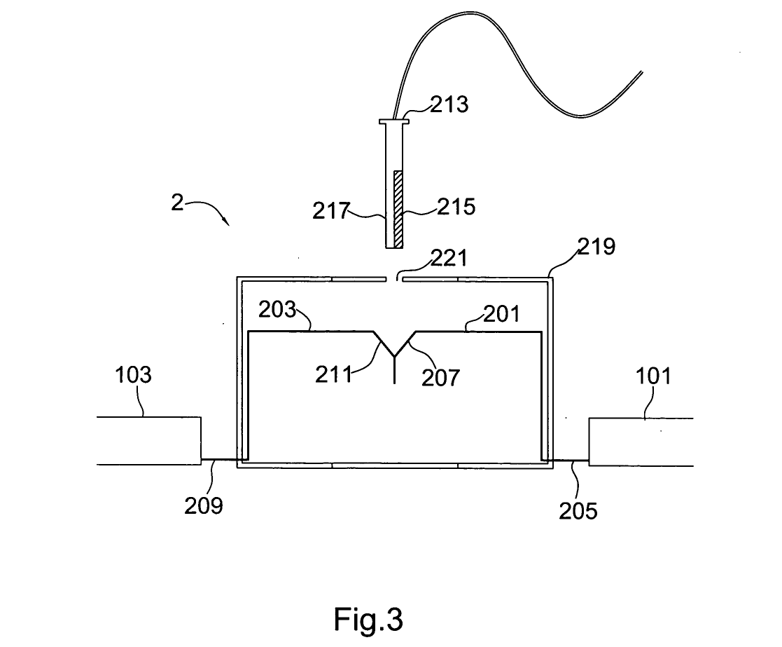

The first conductive wire set 201 and the second conductive wire set 203 do not need to be arc-shaped as set forth above. A second embodiment of the present invention includes a first conductive wire set 201 and the second conductive wire set 203 shaped in such a way as shown in FIG. 3. When the cable 213 is plugged in the connection device 2, the second end 207 of the first conductive wire set 201 and the second end 211 of the second conductive wire set 203, both of which are elastic, are separated by the cable 231 so either the signals of the first unit 101 or the signals of the second unit 103 can be transmitted out.

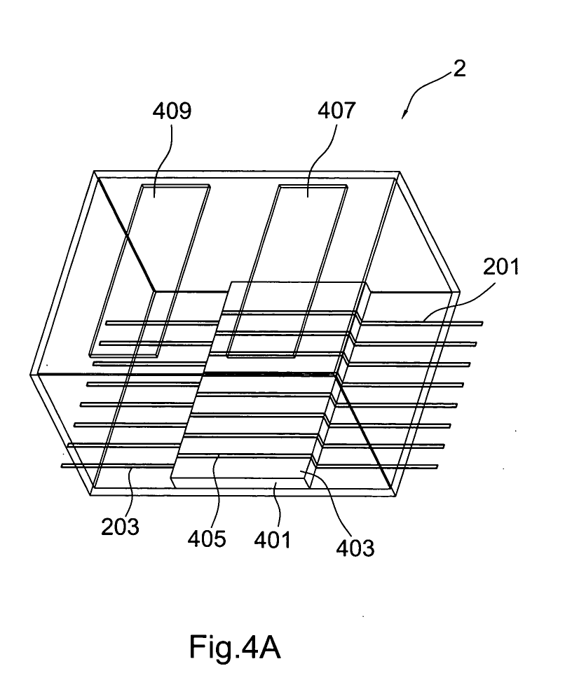

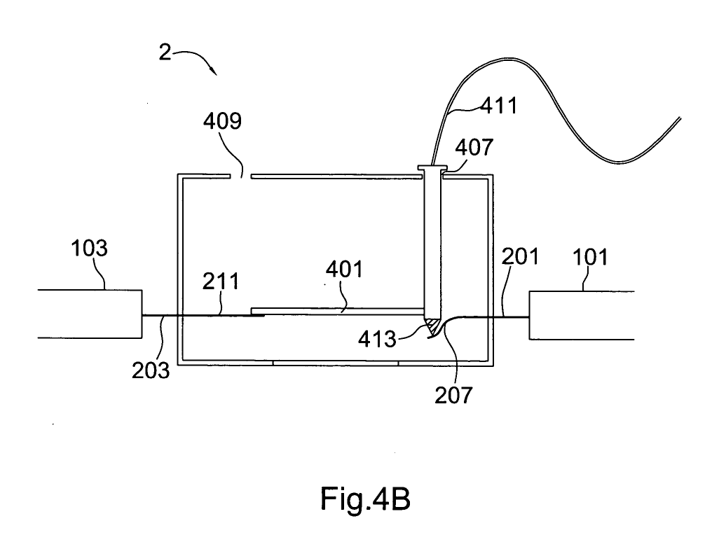

FIG. 4A and FIG. 4B show a third embodiment of the present invention. When the cable 213 is not plugged in the connection device 2, the first conductive wire set 201 and the second conductive wire set 203 are electrically connected via a conductive medium 401 which has an insulation part 403 and a conduction part 405. The first conductive wire set 201 and the second conductive wire set 203 are movably in contact with conduction part 405, i.e. the conduction part 405 merely comes in contact with the surfaces of the first conductive wire set 201 and the second conductive wire set 203; it is not welded to or fixed on the surfaces. The insulation part 403 is configured to separate the elements of the conduction part 405 to avoid shortage. In addition, the third embodiment includes two openings: a first opening 407 and a second opening 409.

When the signals of the first unit 101 are to be retrieved, a cable 411 is plugged in the first opening 407 and then forces the second end 207 of the first conductive wire set 201 to bend downwards in order to separate the conduction part 405 and the second end 207 of the first conductive wire set 201. Only the signals of the first unit 101 will be retrieved from a conductive tip 413 of the cable 411. Similarly, when the signals of the second unit 103 are to be retrieved, a cable 411 is plugged in the second opening 409 and forces the second end 211 of the second conductive wire set 203 to bend downwards in order to separate the conduction part 405 and the second end 211 of the second conductive wire set 203. Only the signals of the second unit 103 will be retrieved from the conductive tip 413 of the cable 411.

According to the present invention, the connection device can retrieve signals separately without damaging system structures. Moreover, the test cables or probes of the prior art are useful for the connection device of the present invention so there is no new cable or probe required for the connection device.

The present invention also provides a system for a flexible flat cable to selectably retrieve electrical signals. The flexible flat cable has been described above. The includes a first unit, a second unit, and a connection device, all of which are also described above.

What is claimed is:

1. A connection device for a retrieval device to selectably retrieve an electrical signal, the connection device being connected to a first unit and a second unit and comprising:
a first conductive wire set having a first end and a second end, the first end being electrically connected to the first unit; and
a second conductive wire set having a first end and a second end, the first end of the second conductive wire being electrically connected to the second unit;
wherein, when the retrieval device is not plugged in the connection device, the second end of the first conductive wire set and the second end of the second conductive wire set are electrically connected so that the first unit and the second unit are electrically connected, and, when the retrieval device is plugged in the connection device, the retrieval device separates the second end of the first conductive wire set and the second end of the second conductive wire set to retrieve the electrical signal from one of the first unit and the second unit.

2. The connection device of claim 1, wherein at least one of the first conductive wire set and the second conductive wire set is elastic.

3. The connection device of claim 1, wherein the retrieval device is a flexible flat cable comprising a signal line for transmitting signals and a flexible plastic insulator for insulation, and, when the flexible flat cable is plugged in the connection device, the signal line and the flexible plastic insulator respectively contact one of the second end of the first conductive wire set and the second end of the second conductive wire set.

4. The connection device of claim 1, further comprising a casing for receiving the first conductive wire set and the second conductive wire set, the casing having an opening for the retrieval device to be plugged in the connection device.

5. A connection device for a flexible flat cable to selectably retrieve an electrical signal, the flexible flat cable comprising a signal line for transmitting signals and a flexible plastic insulator for insulation, the connection device being connected to a first unit and a second unit and comprising:
a first conductive wire set having a first end and a second end, the first end being electrically connected to the first unit;
a second conductive wire set having a first end and a second end, the first end of the second conductive wire being electrically connected to the second unit; and
a casing for receiving the first conductive wire set and the second conductive wire set, the casing having an opening for the flexible flat cable to be plugged in the connection device;
wherein, when the flexible flat cable is not plugged in the connection device, the second end of the first conductive wire set and the second end of the second conductive wire set are electrically connected so that the first unit and the second unit are electrically connected, and, when the flexible flat cable is plugged in the connection device, the flexible flat cable separates the second end of the first conductive wire set and the second end of the second conductive wire set so that the signal line and the flexible plastic insulator respectively contact one of the second end of the first conductive wire set and the second end of the second conductive wire set to retrieve the electrical signal from one of the first unit and the second unit.

6. The connection device of claim 5, wherein at least one of the first conductive wire set and the second conductive wire set is elastic.

7. A system for a flexible flat cable to selectably retrieve an electrical signal, the flexible flat cable comprising a signal line for transmitting signals and a flexible plastic insulator for insulation, the system comprising:
a first unit;
a second unit; and
a connection device, connected to the first unit and the second unit, comprising:
a first conductive wire set having a first end and a second end, the first end being electrically connected to the first unit;
a second conductive wire set having a first end and a second end, the first end of the second conductive wire being electrically connected to the second unit; and
a casing for receiving the first conductive wire set and the second conductive wire set, the casing having an opening for the flexible flat cable to be plugged in the connection device;
wherein, when the flexible flat cable is not plugged in the connection device, the second end of the first conductive wire set and the second end of the second conductive wire set are electrically connected so that the first unit and the second unit are electrically connected, and, when the flexible flat cable is plugged in the connection device, the flexible flat cable separates the second end of the first conductive wire set and the second end of the second conductive wire set so that the signal line and the flexible plastic insulator respectively contact one of the second end of the first conductive wire set and the second end of the second conductive wire set to retrieve the electrical signal from one of the first unit and the second unit.

8. The system of claim 7, wherein at least one of the first conductive wire set and the second conductive wire set is elastic.
